(19) United States
(12) Patent Application Publication
(10) Pub. No.: US 2025/0337012 A1
(43) Pub. Date: Oct. 30, 2025

(54) ELECTROLYTES FOR RECHARGEABLE LITHIUM BATTERIES AND RECHARGEABLE LITHIUM BATTERIES INCLUDING THE SAME

(71) Applicant: SAMSUNG SDI CO., LTD., Yongin-si (KR)

(72) Inventors: Dasol JUN, Yongin-si (KR); Sanghoon KIM, Yongin-si (KR); Hyunbong CHOI, Yongin-si (KR); Sangwoo PARK, Yongin-si (KR); Hongryeol PARK, Yongin-si (KR); Sohee KIM, Yongin-si (KR); Yeji YANG, Yongin-si (KR)

(21) Appl. No.: 18/906,852

(22) Filed: Oct. 4, 2024

(30) Foreign Application Priority Data
Apr. 24, 2024 (KR) 10-2024-0054946

(51) Int. Cl. H01M 10/0567; H01M 4/58; H01M 4/587; H01M 10/0525; H01M 10/0568; H01M 10/0569

(52) U.S. Cl. CPC H01M 10/0567; H01M 4/5825; H01M 4/587; H01M 10/0525; H01M 10/0568; H01M 10/0569; H01M 2300/0025

(57) ABSTRACT

An electrolyte for a rechargeable lithium battery and a rechargeable lithium battery are disclosed. The electrolyte for a rechargeable lithium battery may include a non-aqueous organic solvent; a lithium salt; and an additive represented by Chemical Formula 1.

R-L-N═C═O Chemical Formula 1

### CROSS-REFERENCE TO RELATED APPLICATION

The present application claims priority to and the benefit of Korean Patent Application No. 10-2024-0054946, filed on Apr. 24, 2024, in the Korean Intellectual Property Office, the entire disclosure of which is incorporated herein by reference.

### BACKGROUND

### 1. Field

One or more embodiments of the present disclosure relate to an electrolyte for rechargeable lithium batteries and a rechargeable lithium battery including the electrolyte.

### 2. Description of the Related Art

A rechargeable lithium battery may be recharged and has three or more times as high energy density per unit weight as a lead storage battery, a nickel-cadmium battery, a nickel hydrogen battery, a nickel zinc battery, and/or the like. It may also be charged at a high rate and thus, may be commercially manufactured for a laptop, a cell phone, an electric tool, an electric bike, and/or the like. Research on improvement of additional energy density has been actively made.

Such a rechargeable lithium battery is manufactured by injecting an electrolyte into an electrode assembly which includes a positive electrode including a positive electrode active material that is capable of intercalating/deintercalating lithium ions and a negative electrode including a negative electrode active material that is capable of intercalating/deintercalating lithium ions.

If (e.g., when) such a rechargeable lithium battery is continuously charged and discharged and/or stored at a high temperature, a lithium salt (e.g., LiPF₆) in the electrolyte may react with moisture (e.g., H₂O) to produce undesirable hydrogen fluoride (HF), and the HF may elute transition metal (e.g., Fe) ions from the positive electrode active material. The transition metal ions eluted from the positive electrode active material may be precipitated as metals on the negative electrode surface after moving through the electrolyte and react with moisture inside the rechargeable lithium battery to generate gas and/or increase resistance, thereby accelerating degradation of the rechargeable lithium battery.

### SUMMARY

In one or more embodiments, by effectively removing moisture (e.g., H₂O) in a rechargeable lithium battery, an undesirable side reaction between a lithium salt (e.g., LiPF₆) and moisture (e.g., H₂O) may be suppressed or reduced (or a degree or occurrence of an undesirable side reaction between a lithium salt (e.g., LiPF₆) and moisture (e.g., H₂O) may be reduced), and side reactions with transition metal ions eluted from the positive electrode active material may be suppressed or reduced (or a degree or occurrence of side reactions with transition metal ions eluted from the positive electrode active material may be reduced), and ultimately, an electrolyte for a rechargeable lithium battery that may improve or enhance charging/discharging and/or high-temperature storage characteristics of a rechargeable lithium battery may be provided.

One or more aspects of embodiments of the present disclosure are directed toward a rechargeable lithium battery including an electrolyte for a rechargeable lithium battery.

Additional aspects will be set forth in part in the description which follows and, in part, will be apparent from the description, or may be learned by practice of the presented embodiments of the disclosure.

The electrolyte for a rechargeable lithium battery may include a non-aqueous (e.g., water-insoluble) organic solvent; a lithium salt; and an additive represented by Chemical Formula 1:

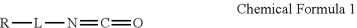

In Chemical Formula 1, R may be a substituted or unsubstituted C3 to C20 cycloalkyl group; and L may be a single bond (e.g., a single covalent bond) or a substituted or unsubstituted C1 to C20 alkylene group.

One or more embodiments of the present disclosure provide a rechargeable lithium battery that may include a positive electrode including a positive electrode active material, a negative electrode including a negative electrode active material, and an electrolyte.

The electrolyte for a rechargeable lithium battery according to one or more embodiments may suppress or reduce a reaction between a lithium salt (e.g., LiPF₆) and moisture (e.g., H₂O) (or a degree or occurrence of a reaction between a lithium salt (e.g., LiPF₆) and moisture (e.g., H₂O) may be reduced), suppress or reduce side reactions with transition metal ions eluted from the positive electrode active material (or a degree or occurrence of side reactions with transition metal ions eluted from the positive electrode active material may be reduced), and ultimately improve or enhance charging/discharging and/or high-temperature storage characteristics at a high temperature of the rechargeable lithium battery.

### BRIEF DESCRIPTION OF THE DRAWINGS

The above and other aspects and features of certain embodiments of the present disclosure will be more apparent from the following description taken in conjunction with the accompanying drawings, in which:

FIGS. 1-4 each is a schematic view illustrating rechargeable lithium batteries according to one or more embodiments.

### DETAILED DESCRIPTION

Hereinbefore, certain embodiments of the present disclosure have been described and illustrated, however, it should be apparent to a person having ordinary skill in the art that the present disclosure is not limited to the embodiments as described, and may be suitably modified and transformed without departing from the spirit and scope of the present disclosure. In one or more embodiments, the modified or transformed embodiments as such may not be understood separately from the technical ideas and aspects of one or more embodiments of the present disclosure, and the modified embodiments may be within the scope of the appended claims and equivalents thereof of the present disclosure.

As utilized herein, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”.

In the context of the present disclosure and unless otherwise defined, the terms “use,” “using,” and “used” may be considered synonymous with the terms “utilize,” “utilizing,” and “utilized,” respectively.

As utilized herein, the term “about” or similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations, or within +30%, 20%, 10%, or 5% of the stated value.

Any numerical range recited herein is intended to include all sub-ranges of substantially the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend the present disclosure, including the appended claims, to expressly recite any sub-range subsumed within the ranges expressly recited herein.

As used herein, if (e.g., when) specific definition is not otherwise provided, it will be understood that if (e.g., when) an element, such as a layer, film, region, or substrate, is referred to as being “on” another element, it may be directly on the other element or intervening elements may also be present.

As used herein, if (e.g., when) specific definition is not otherwise provided, the singular may also include the plural. In addition, unless otherwise specified, “A or B” may refer to “including A, including B, or including A and B.”

As used herein, “combination thereof” may refer to a mixture of constituents, a stack, a composite, a copolymer, an alloy, a blend, and a reaction product.

As used herein, if (e.g., when) specific definition is not otherwise provided, “substituted” refers to replacement of at least one hydrogen atom of a compound by a substituent selected from among a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, or a combination thereof.

As used herein, if (e.g., when) specific definition is not otherwise provided, “heterocycloalkyl group,” “heterocycloalkenyl group,” “heterocycloalkynyl group,” and “heterocycloalkylene group” refer to that at least one heteroatom of nitrogen (N), oxygen (O), sulfur(S), or phosphorus (P) is present in the ring compound of cycloalkyl, cycloalkenyl, cycloalkynyl, and cycloalkylene, respectively.

In chemical formulas of the present specification, unless a specific definition is otherwise provided, a hydrogen atom (H) may be bonded at the position if (e.g., when) a chemical bond is not drawn where supposed to be given.

### Electrolyte

One or more embodiments of the present disclosure provide an electrolyte for a rechargeable lithium battery that may include a non-aqueous (e.g., water-insoluble) organic solvent; a lithium salt; and an additive represented by Chemical Formula 1:

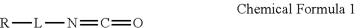

In Chemical Formula 1, R may be a substituted or unsubstituted C3 to C20 cycloalkyl group; and L may be a single bond (e.g., a single covalent bond) or a substituted or unsubstituted C1 to C20 alkylene group.

The additive represented by Chemical Formula 1 may be a compound containing or including a cycloalkyl group and/or an isocyanate group, and the isocyanate group may react with moisture to convert into an amine group and concurrently (e.g., simultaneously) generate carbon dioxide (CO₂). In one or more embodiments, the cycloalkyl group may increase or enhance the polarity of the compound represented by Chemical Formula 1 compared to the alkyl group and may improve or enhance the reactivity of the isocyanate group with moisture.

In one or more embodiments, the electrolyte of one or more embodiments may suppress or reduce a reaction between a lithium salt (e.g., LiPF₆) and moisture (e.g., H₂O) (or a degree or occurrence of a reaction between a lithium salt (e.g., LiPF₆) and moisture (e.g., H₂O) may be reduced) by effectively removing moisture in a rechargeable lithium battery, suppress or reduce side reactions with transition metal ions eluted from the positive electrode active material (or a degree or occurrence of side reactions with transition metal ions eluted from the positive electrode active material may be reduced), and ultimately improve or enhance charging/discharging and/or high-temperature storage characteristics of a rechargeable lithium battery.

Hereinafter, the electrolyte according to one or more embodiments will be described in more detail.

### Additive

R may be a substituted or unsubstituted C3 to C10 cycloalkyl group.

For example, R may be a substituted or unsubstituted C5 to C6 cycloalkyl group.

For example, R may be a substituent represented by Chemical Formula 2-1 or 2-2:

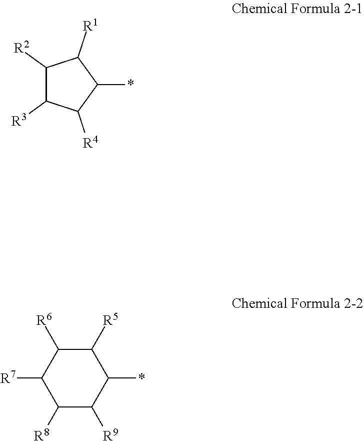

In Chemical Formulas 2-1 and 2-2, R¹ to R⁹ may each independently be a hydrogen atom, a halogen atom, or a C1 to C20 alkyl group.

Representative examples of additives represented by Chemical Formula 1 are as follows:

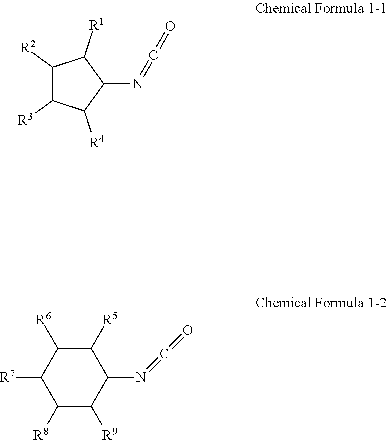

In Chemical Formulas 1-1 and 1-2, R¹ to R⁹ may each independently be a hydrogen atom, a halogen atom, or a C1 to C20 alkyl group.

For example, R¹ to R⁹ may all be hydrogen atoms.

The additive represented by Chemical Formula 1 may be included in an amount of about 0.01 to about 10 wt %, about 0.1 to about 5 wt %, or about 0.1 to about 1 wt % based on 100 wt % of a total amount of the electrolyte for a rechargeable lithium battery.

Within the above range, the effect of the additive represented by Chemical Formula 1 may be suitably optimized or adjusted.

### Additional Additive

The additive may further include other compounds (hereinafter referred to as “additional additives”) in addition to the additive represented by Chemical Formula 1.

The additional additive may include cyclic carbonates. The cyclic carbonate may be, for example, vinyl ethylene carbonate (VEC), vinylene carbonate (VC), ethylene carbonate, a derivative thereof, or a combination thereof. The derivative of ethylene carbonate (EC) may include, for example, fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, and/or the like.

In one or more embodiments, the additional additive may further include succinonitrile (SN), adiponitrile (AN), 1,3,6-hexane tricyanide (HTCN), propenesultone (PST), propanesultone (PS), lithium tetrafluoroborate (LiBF₄), lithium difluorophosphate (LiPO₂F₂), 2-fluoro biphenyl (2-FBP), or a combination thereof.

The additional additive may be included in an amount of about 0.1 wt % to about 10 wt %, about 0.5 wt % to about 9 wt %, about 1 wt % to about 8 wt %, about 1 wt % to about 7 wt %, about 1 wt % to about 6 wt %, or about 2 wt % to about 5 wt %, based on 100 wt % of a total amount of the electrolyte for a rechargeable lithium battery. If (e.g., when) the amount of the additional additive satisfies the above range, cycle-life characteristics may be improved or enhanced, and the gas generation amount and/or resistance increase rate may be effectively or suitably controlled without adversely affecting the battery.

### Non-Aqueous Organic Solvent

The non-aqueous (e.g., water-insoluble) organic solvent may serve as a medium that transmits ions taking part in or suitably adjusting the electrochemical reaction of a rechargeable lithium battery.

The non-aqueous (e.g., water-insoluble) organic solvent may be a carbonate-based, ester-based, ether-based, ketone-based, alcohol-based solvent, aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethyl methyl carbonate (EMC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone. The alcohol-based solvent may include ethyl alcohol, isopropyl alcohol, and/or the like, and the aprotic solvent may include nitriles, such as R—CN (wherein R may be a C2 to C20 linear, branched, or cyclic hydrocarbon group, a double bond, an aromatic ring, or an ether group), amides, such as dimethylformamide, dioxolanes, such as 1,3-dioxolane or 1,4-dioxolane, sulfolanes, and/or the like.

The non-aqueous (e.g., water-insoluble) organic solvent may be used alone or in combination of two or more non-aqueous (e.g., water-insoluble) organic solvents.

In one or more embodiments, if (e.g., when) a carbonate-based solvent is used, cyclic carbonate and chain carbonate may be mixed and used, and cyclic carbonate and chain carbonate may be mixed at a volume ratio of about 1:1 to about 1:9.

For example, the non-aqueous (e.g., water-insoluble) organic solvent may be a mixture of ethylene carbonate (EC), ethyl methyl carbonate (EMC), and diethyl carbonate (DEC). Their volume ratio (e.g., a volume ratio of ethylene carbonate (EC), ethyl methyl carbonate (EMC), and diethyl carbonate (DEC) in a mixture) may not be particularly limited. In one or more embodiments, their volume ratio (e.g., a volume ratio of ethylene carbonate (EC), ethyl methyl carbonate (EMC), and diethyl carbonate (DEC) in a mixture) may be suitably adjusted or modified.

### Lithium Salt

The lithium salt dissolved in an organic solvent may supply lithium ions in a rechargeable lithium battery, enable a basic operation of a rechargeable lithium battery, and/or improve transportation of the lithium ions between positive and negative electrodes. Examples of a lithium salt may include one or more than one selected from among LiPF₆, LiBF₄, LiSbF₆, LiAsF₆, LiClO₄, LIAlO₂, LiAlCl₄, LIPO₂F₂, LICl, LiI, LIN (SO₃C₂F₅)₂, Li(FSO₂)₂N (lithium bis(fluorosulfonyl)imide, LiFSI), LiC₄F₉SO₃, LIN(CₓF₂ₓ₊₁SO₂) (C_{y}F_{2y+1}SO₂) (wherein x and y may each independently be integers of 1 to 20), lithium trifluoromethane sulfonate, lithium tetrafluoroethanesulfonate, lithium difluorobis(oxalato)phosphate, (LiDFOB), and lithium bis(oxalato) borate (LiBOB).

For example, LiPF₆ may be used as the lithium salt. For example, the lithium salt may include LiPF₆.

A molar concentration of the lithium salt in the electrolyte may be about 1.0 to about 2.0 M.

### Rechargeable Lithium Battery

One or more embodiments of the present disclosure provide a rechargeable lithium battery that may include the electrolyte for a rechargeable lithium battery according to one or more embodiments.

By including the electrolyte for a rechargeable lithium battery according to the one or more embodiments, a reaction between a lithium salt (e.g., LiPF₆) and moisture (e.g., H₂O) may be suppressed or reduced (or a degree or occurrence of a reaction between a lithium salt and moisture may be reduced), and the side reaction with transition metal ions eluted from the positive electrode active material may be suppressed or reduced (or a degree or occurrence of the side reaction with transition metal ions eluted from the positive electrode active material may be reduced), and ultimately, charging/discharging and/or high-temperature storage characteristics of a rechargeable lithium battery may be improved or enhanced.

Hereinafter, the configuration or arrangement of the rechargeable lithium battery will be described, excluding descriptions that may overlap with the above.

### Positive Electrode Active Material

The positive electrode active material may be a compound (e.g., a lithiated intercalation compound) capable of intercalating and deintercalating lithium. For example, one or more types or kinds of composite oxides of lithium and a metal selected from among cobalt (Co), manganese (Mn), nickel (Ni), and combinations thereof may be used.

The composite oxide may be a lithium transition metal composite oxide, and, for example, may include a lithium nickel-based oxide, a lithium cobalt-based oxide, a lithium manganese-based oxide, a lithium iron phosphate-based compound, a cobalt-free lithium nickel-manganese-based oxide, or a combination thereof.

As an example, a compound represented by any selected from among the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, O≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A may be nickel (Ni), cobalt (Co), manganese (Mn), or a combination thereof; X may be aluminum (Al), Ni, Co, Mn, chromium (Cr), iron (Fe), magnesium (Mg), strontium (Sr), vanadium (V), a rare earth element, or a combination thereof; D may be oxygen (O), fluorine (F), sulfur(S), phosphorus (P), or a combination thereof; G may be Al, Cr, Mn, Fe, Mg, lanthanum (La), cerium (Ce), Sr, V, or a combination thereof; and L¹ may be Mn, Al, or a combination thereof.

The positive electrode active material may be, for example, a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

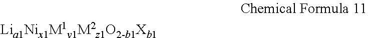

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be one or more selected from among aluminum (Al), boron (B), barium (Ba), calcium (Ca), cerium (Ce), cobalt (Co), chromium (Cr), copper (Cu), iron (Fe), magnesium (Mg), manganese (Mn), molybdenum (Mo), niobium (Nb), silicon (Si), tin (Sn), strontium (Sr), titanium (Ti), vanadium (V), tungsten (W), and zirconium (Zr), and X may be one or more selected from among fluorine (F), phosphorus (P), and sulfur(S).

In Chemical Formula 11, 0.6≤x1≤1, 0≤y1≤0.4, and 0≤z1≤0.4, or 0.8≤x1≤1, 0≤y1≤0.2, and 0≤z1≤0.2.

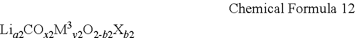

In Chemical Formula 12, 0.9≤a2≤1.8, 0.7≤x2≤1, 0≤y2≤0.3, 0.9≤x2+y2≤1.1, and 0≤b2≤0.1, M³ may be one or more selected from among Al, B, Ba, Ca, Ce, Cr, Cu, Fe, Mg, Mn, Mo, Ni, Se, Si, Sn, Sr, Ti, V, W, Y, Zn, and Zr, and X may be one or more selected from among F, P, and S.

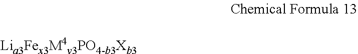

In Chemical Formula 13, 0.9≤a3≤1.8, 0.6≤x3≤1, 0≤y3≤0.4, and 0≤b3≤0.1, M⁴ may be one or more selected from among aluminum (Al), boron (B), barium (Ba), calcium (Ca), cerium (Ce), cobalt (Co), chromium (Cr), copper (Cu), magnesium (Mg), manganese (Mn), molybdenum (Mo), nickel (Ni), selenium (Se), silicon (Si), tin (Sn), strontium (Sr), titanium (Ti), vanadium (V), tungsten (W), yttrium (Y), zinc (Zn), and zirconium (Zr), and X may be one or more selected from among fluorine (F), phosphorus (P), and sulfur(S).

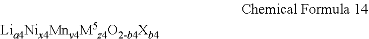

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1, M⁵ may be one or more element selected from among Al, B, Ba, Ca, Ce, Cr, Fe, Mg, Mo, Nb, Si, Sn, Sr, Ti, V, W, and Zr, and X may be one or more selected from among F, P, and S.

For example, a lithium iron phosphate-based compound represented by Chemical Formula 13 may be used as the positive electrode active material.

Iron ions eluted from the lithium iron phosphate-based compound represented by Chemical Formula 13 may have high reactivity with moisture in a rechargeable lithium battery. Nevertheless, if (e.g., when) the electrolyte according to one or more embodiments is used according to one or more embodiments, the additive represented by Chemical Formula 1 may remove or reduce moisture (e.g., amount of moisture) in the rechargeable lithium battery, suppress or reduce side reactions with transition metal ions eluted from the positive electrode active material (or a degree or occurrence of side reactions with transition metal ions eluted from the positive electrode active material may be reduced), and ultimately, improve or enhance charging/discharging and/or high-temperature storage characteristics of rechargeable lithium batteries.

### Positive Electrode

The positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that may function as a sacrificial positive electrode.

An amount of the positive electrode active material may be about 90 wt % to about 99.5 wt %, and each amount of the binder and the conductive material (e.g., the electrically conductive material) may be about 0.5 wt % to about 5 wt % based on 100 wt % of the positive electrode active material layer.

The binder may serve to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, but embodiments of the present disclosure are not limited thereto.

The conductive material (e.g., the electrically conductive material) may be used to impart conductivity (e.g., electrical conductivity) to the electrode. Any suitable material that does not cause chemical change (e.g., does not cause an undesirable chemical change in the rechargeable lithium battery) and conducts electrons may be used in the battery. Examples of the conductive material (e.g., the electrically conductive material) may include a carbon atom (C)-based material, such as natural graphite, artificial graphite, carbon black, acetylene black, ketjen black, a carbon fiber, a carbon nanofiber, and carbon nanotube; a metal-based material including copper (Cu), nickel (Ni), aluminum (Al), silver (Ag), and/or the like, in a form of a metal powder and/or a metal fiber; a conductive polymer (e.g., an electrically conductive polymer), such as a polyphenylene derivative; or a mixture thereof.

The current collector may include Al, but embodiments of the present disclosure are not limited thereto.

### Negative Electrode Active Material

The negative electrode active material may be a material that reversibly intercalates/deintercalates lithium ions, a lithium metal, a lithium metal alloy, a material capable of doping and dedoping lithium, and/or a transition metal oxide.

The material that reversibly intercalates/deintercalates lithium ions may include a carbon atom (C)-based negative electrode active material, for example, crystalline carbon, amorphous carbon, or a combination thereof. The crystalline carbon may be graphite, such as non-shaped (e.g., irregularly shaped), plate-shaped (e.g., generally plate-shaped), flake-shaped (e.g., generally flake-shaped), sphere-shaped (e.g., generally sphere-shaped), and/or fiber-shaped (e.g., generally fiber-shaped) natural graphite and/or artificial graphite. The amorphous carbon may be a soft carbon, a hard carbon, a mesophase pitch carbonization product, calcined coke, and/or the like.

The lithium metal alloy may include lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a silicon atom (Si)-based negative electrode active material and/or a tin atom (Sn)-based negative electrode active material. The Si-based negative electrode active material may include silicon, a silicon-carbon composite, SiOₓ (0<x≤2), a Si-Q alloy (wherein Q may be selected from among an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnOₖ (0<k≤2) (e.g., SnO₂), an Sn-based alloy, or a combination thereof.

The silicon-carbon composite may be a composite of silicon and amorphous carbon. According to one or more embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material and/or the Sn-based negative electrode active material may be used in combination with a carbon-based negative electrode active material.

### Negative Electrode

A negative electrode for a rechargeable lithium battery may include a current collector and a negative electrode active material layer on the current collector. The negative electrode active material layer may include a negative electrode active material and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0.5 wt % to about 5 wt % of the conductive material (e.g., the electrically conductive material).

The binder may serve to attach the negative electrode active material particles well to each other and also to attach the negative electrode active material well to the current collector. The binder may include a non-aqueous (e.g., water-insoluble) binder, an aqueous (e.g., water-soluble) binder, a dry binder, or a combination thereof.

The non-aqueous (e.g., water-insoluble) binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous (e.g., water-soluble) binder may be selected from among a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If (e.g., when) an aqueous (e.g., water-soluble) binder is used as the negative electrode binder, it may further include a cellulose-based compound capable of imparting or increasing viscosity. The cellulose-based compound may include one or more selected from among carboxylmethyl cellulose, hydroxypropyl methylcellulose, methyl cellulose, or alkali metal salts thereof. The alkali metal may be Na, K, and/or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, or a combination thereof.

The conductive material (e.g., the electrically conductive material) may provide electrode conductivity, and any suitable electrically conductive material may be used as a conductive material unless it causes a chemical change (e.g., an undesirable chemical change in the rechargeable lithium battery). Examples of the conductive material (e.g., the electrically conductive material) may be a carbon-based material, such as natural graphite, artificial graphite, carbon black, acetylene black, ketjen black, a carbon fiber, a carbon nanofiber, a carbon nanotube, and/or the like; a metal-based material, such as copper, nickel, aluminum silver, and/or the like, in a form of a metal powder and/or a metal fiber; a conductive polymer (e.g., an electrically conductive polymer), such as a polyphenylene derivative; or a mixture thereof.

The negative electrode current collector may include one selected from among a copper foil, a nickel foil, a stainless steel foil, a titanium foil, a nickel foam, a copper foam, a polymer substrate coated with a conductive metal (e.g., an electrically conductive metal), and a combination thereof, but embodiments of the present disclosure are not limited thereto.

### Separator

Depending on the type or kind of the rechargeable lithium battery, a separator may be present or provided between the positive electrode and the negative electrode. The separator may include polyethylene, polypropylene, polyvinylidene fluoride, or a multilayer film of two or more layers thereof, and a mixed multilayer film, such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, or a combination thereof on one surface or both surfaces (e.g., two opposing surfaces) of the porous substrate.

The porous substrate may be a polymer film including any one selected from among a polymer, or a copolymer or mixture of two or more of polyolefin, such as polyethylene or polypropylene, a polyester, such as polyethylene terephthalate, or polybutylene terephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylene sulfide, polyethylene naphthalate, a glass fiber, and polytetrafluoroethylene (e.g., Teflon™).

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but embodiments of the present disclosure are not limited thereto.

The organic material and the inorganic material may be mixed in one coating layer, or a coating layer including an organic material and a coating layer including an inorganic material may be stacked.

### Rechargeable Lithium Battery

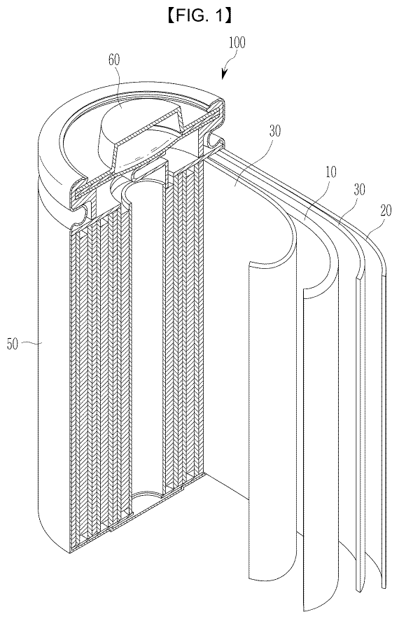

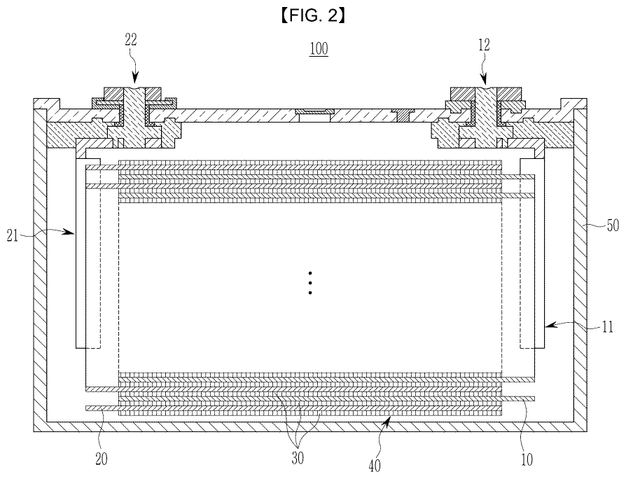

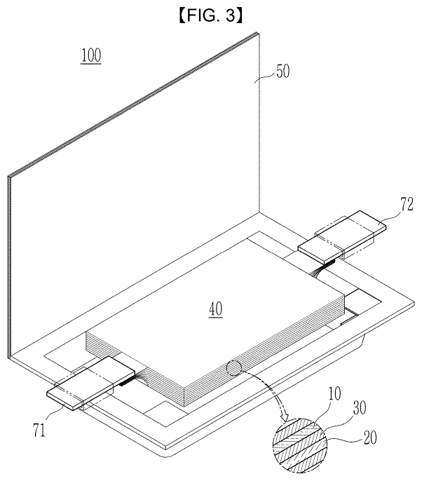

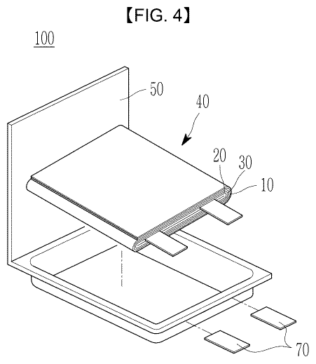

The rechargeable lithium battery may be classified into cylindrical, prismatic, pouch, or coin-type or kind batteries, and/or the like depending on their shape. FIGS. 1-4 each is a schematic view illustrating a rechargeable lithium battery according to one or more embodiments. FIG. 1 is a schematic view illustrating a circular battery, FIG. 2 is a schematic view illustrating a prismatic battery, and FIGS. 3-4 each is a schematic view illustrating pouch-type batteries. Referring to FIGS. 1-4, the rechargeable lithium battery 100 may include an electrode assembly 40 including a separator 30 between a positive electrode 10 and a negative electrode 20, and a case 50 in which the electrode assembly 40 may be housed. The positive electrode 10, the negative electrode 20, and the separator 30 may be impregnated with an electrolyte. The rechargeable lithium battery 100 may include a sealing member 60 that seals the case 50 as shown in FIG. 1. In one or more embodiments, in FIG. 2, the rechargeable lithium battery 100 may include a positive lead tab 11, a positive terminal 12, a negative lead tab 21, and a negative terminal 22. As shown in FIGS. 3-4, the rechargeable lithium battery 100 may include an electrode tab 70, for example, a positive electrode tab 71 and a negative electrode tab 72 serving as an electrical path to induce the current formed or provided in the electrode assembly 40 to the outside.

The rechargeable lithium battery according to one or more embodiments may be applied to automobiles, mobile phones, and/or one or more suitable types or kinds of electrical devices, but embodiments of the present disclosure are not limited thereto.

Hereinafter, examples of the present disclosure and comparative examples are described. These examples, however, are not in any sense to be interpreted as limiting the scope of the present disclosure.

### Example 1

### (1) Preparation of Electrolyte

A LiPF₆ lithium salt was mixed at a concentration of 1.5 M in an organic solvent in which ethylene carbonate (EC), ethyl methyl carbonate (EMC), and diethyl carbonate (DEC) were mixed at a volume ratio of 2:4:4, and 0.5 wt % of an additive represented by Chemical Formula 1-1 was added thereto to prepare an electrolyte.

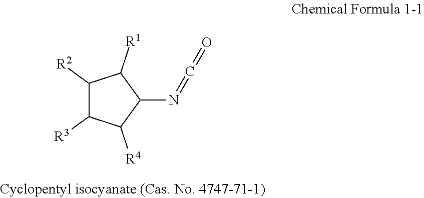

In Chemical Formula 1-1, R¹ to R⁴ are all hydrogen atoms.

However, in the electrolyte composition, “wt %” was based on a total amount of the electrolyte (e.g., a lithium salt+non-aqueous (e.g., water-insoluble) organic solvent+additive). Hereinafter, substantially the same as above was applied.

### (2) Manufacturing of Positive Electrode

A positive electrode active material layer slurry was prepared by mixing 97.7 wt % of LifePO₄ as a positive electrode active material, 1.3 wt % of a polyvinylidene fluoride binder, and 1.0 wt % of a carbon nanotube conductive material, and was coated on an aluminum foil current collector, dried and pressed to manufacture a positive electrode.

### (3) Manufacturing of Negative Electrode

A negative electrode active material layer slurry was prepared by mixing 97.5 wt % of a graphite negative electrode active material, 1.5 wt % of carboxymethyl cellulose, and 1 wt % of styrene butadiene rubber in a water solvent. A negative electrode was manufactured by coating the negative electrode active material layer slurry on a copper foil current collector, drying, and pressing.

### (4) Manufacturing of Rechargeable Lithium Battery Cell

The positive and negative electrodes were assembled with a 25 μm-thick polyethylene separation membrane to manufacture an electrode assembly, the electrode assembly was housed in a prismatic case, and the electrolyte was implanted thereinto, manufacture a rechargeable lithium battery cell.

### Example 2

The electrolyte and rechargeable lithium battery cell according to Example 2 were manufactured in substantially the same manner as Example 1, except that the amount of the additive represented by Chemical Formula 1-1 was changed to 1 wt %.

### Example 3

The electrolyte and rechargeable lithium battery cell according to Example 3 were manufactured in substantially the same manner as Example 1, except that the additive represented by Chemical Formula 1-2 was used instead of the additive represented by Chemical Formula 1-1:

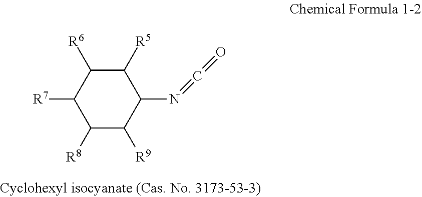

In Chemical Formula 1-2, R⁵ to R⁹ are all hydrogen atoms.

### Example 4

The electrolyte and rechargeable lithium battery cell according to Example 4 were manufactured in substantially the same manner as Example 1, except that a content (e.g., amount) of the additive represented by Chemical Formula 1-2 was changed to 11 wt %.

### Comparative Example 1

The electrolyte and rechargeable lithium battery cell according to Comparative Example 1 were manufactured in substantially the same manner as Example 1, except that the additive represented by Chemical Formula 1-1 was not used.

### Comparative Example 2

The electrolyte and rechargeable lithium battery cell according to Comparative Example 2 were manufactured in substantially the same manner as Example 1, except that an additive represented by Chemical Formula 3 was used instead of the additive represented by Chemical Formula 1-1:

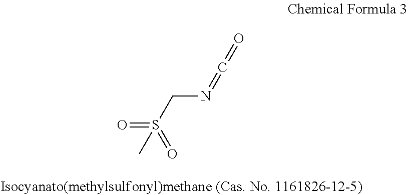

### Comparative Example 3

The electrolyte and rechargeable lithium battery cell according to Comparative Example 3 were manufactured in substantially the same manner as Example 1, except that an additive represented by Chemical Formula 4 was used instead of the additive represented by Chemical Formula 1-1:

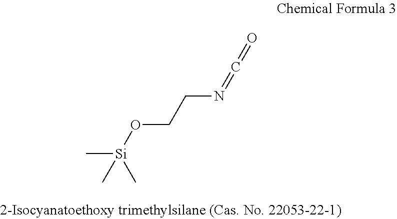

For reference, the types (or kinds) and contents (e.g., amounts) of each additive in Examples 1 to 4 and Comparative Examples 1 to 3 are summarized in Table 1.

TABLE 1

| | Additive | |
|---|---|---|
| | | Content (e.g., |
| | | amount) in |
| | Type | electrolyte (wt %) |
| Example 1 | Chemical Formula 1-1 | 0.5 |
| Example 2 | Chemical Formula 1-1 | 1 |
| Example 3 | Chemical Formula 1-2 | 0.5 |
| Example 4 | Chemical Formula 1-2 | 1 |
| Comparative Example 1 | — | — |
| Comparative Example 2 | Chemical Formula 3 | 0.5 |
| Comparative Example 3 | Chemical Formula 4 | 0.5 |

### Evaluation Example 1: Room-Temperature Charging/Discharging Characteristics

The rechargeable lithium battery cells according to Examples 1 to 4 and Comparative Examples 1 to 3 were 200 cycles charged at 0.33 C (CC/CV, 3.65 V, cut-off at 0.02 C)/discharged at 1.0 C (CC, cut-off at 2.5 V) at 25° C. to calculate a capacity retention ratio (CRR) according to Equation 1. The capacity retention rates of Examples 1 to 4 and Comparative Examples 1 to 3 are shown in Table 2.

$$Capacity retention rate [ \% ] = Discharge capacity after 200 cycles / Discharge capacity after 1 {cycle}^{*} 100 \qquad Equation 1$$

TABLE 2

| | Capacity retention rate [%] |
|---|---|
| | @ 25° C., 200 Cyc. |
| Example 1 | 96.3 |
| Example 2 | 96.7 |
| Example 3 | 94.5 |
| Example 4 | 94.9 |
| Comparative Example 1 | 83.7 |
| Comparative Example 2 | 92.1 |
| Comparative Example 3 | 90.8 |

### Evaluation Example 2: High-Temperature Storage Characteristics

### (1) DC-IR Increase Rate

The rechargeable lithium battery cells according to Examples 1 to 4 and Comparative Examples 1 to 3 were measured with respect to initial DC internal resistance (DCIR) by ΔV/ΔI (voltage change/current change) and then, DC resistance after making a maximum energy state of each of the cells into a full-charge state (SOC 100%) and then, storing the cells in this state at a high temperature (60° C.) for 7 days to calculate a DC-IR increase rate (%) according to Equation 2, and the results are shown in Table 3:

$$DC - IR increase rate [ \% ] = {( DC - IR after 7 days of high - temperature storage / initial DC - IR )}^{*} 100 \qquad Equation 2$$

### (2) Gas Increase Rate

The rechargeable lithium battery cells of Examples 1 to 4 and Comparative Examples 1 to 3 were measured with respect to a gas generation amount immediately after the formation charge and discharge in the Archimedes method (an initial gas generation amount). Subsequently, the cells, after making a maximum energy state inside the battery cells to a full-charge state (SOC 100%) and storing them in this state at a high temperature (60° C.) for 7 days, were measured with respect to a gas generation amount in substantially the same method as above to calculate a gas increase rate (%) according to Equation 3, and the results are shown in Table 3:

$$Gas increase rate [ \% ] = {( amount of gas generated after 7 days of high temperature storage / initial gas generation amount )}^{*} 100 \qquad Equation 3$$

TABLE 3

| | DC-IR increase rate | Gas increase rate |
|---|---|---|
| | [%] | [%] |
| Example 1 | 15 | 39 |
| Example 2 | 14 | 35 |
| Example 3 | 18 | 43 |
| Example 4 | 19 | 41 |
| Comparative Example 1 | 58 | 79 |
| Comparative Example 2 | 30 | 51 |
| Comparative Example 3 | 32 | 53 |

### SUMMARY

Referring to Tables 2 and 3, the rechargeable lithium battery cells using each of the electrolytes of Examples 1 to 4, compared to that using the electrolyte of Comparative Example 1, exhibited 10% or more improved 200 cycle-life characteristics (capacity retention rate) and thus significantly reduced DC-IR increase rate and gas increase rate after the high-temperature storage.

In one or more embodiments, referring to Examples 1 to 4, a type (or kind) and/or an amount of the additive represented by Chemical Formula 1 may be adjusted to control its effect.

However, the rechargeable lithium battery cells respectively using the electrolytes of Comparative Examples 2 and 3, compared to the cell using the electrolyte of Comparative Example 1, exhibited an increase in the 200 cycle-life characteristics (capacity retention) and a decrease in the DC-IR increase rate and the gas increase rate after the high-temperature storage, which were inferior to those of the cells of Examples 1 to 4. Herein, the cycloalkyl group, compared to an alkyl group, was confirmed to increase polarity of the compound represented by Chemical Formula 1 and improve reactivity between the isocyanate group and moisture.

In one or more embodiments, the electrolyte according to one or more embodiments, which was represented by Examples 1 to 4, was confirmed to effectively remove moisture inside the rechargeable lithium battery cells to suppress or reduce a reaction of a lithium salt and the moisture and suppress or reduce a side reaction with transition metal ions eluted from a positive electrode active material, ultimately improving or enhancing charging/discharging and/or high-temperature storage characteristics of the rechargeable lithium battery cells.

While the subject matter of the present disclosure has been described in connection with what is presently considered to be practical embodiments, it is to be understood that embodiments of the present disclosure are not limited to the disclosed embodiments, but, on the contrary, are intended to cover one or more suitable modifications and equivalent arrangements included within the spirit and scope of the appended claims and equivalents thereof. It therefore will be understood that one or more embodiments described above are just illustrative but not limitative in all aspects.

Description of Symbols

| | |
|---|---|
| 100: rechargeable lithium battery | 10: positive electrode |
| 11: positive electrode lead tab | 12: positive terminal |
| 20: negative electrode | 21: negative electrode lead |
| 22: negative terminal | 30: separator |
| 40: electrode assembly | 50: case |
| 60: sealing member | 70: electrode tab |
| 71: positive electrode tab | 72: negative electrode tab |

What is claimed is:

1. An electrolyte for a rechargeable lithium battery, comprising:
a non-aqueous organic solvent;
a lithium salt; and
an additive represented by Chemical Formula 1: 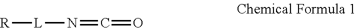
wherein, in Chemical Formula 1,
R is a substituted or unsubstituted C3 to C20 cycloalkyl group; and
L is a single bond or a substituted or unsubstituted C1 to C20 alkylene group.

2. The electrolyte as claimed in claim 1, wherein:
R is a substituted or unsubstituted C3 to C10 cycloalkyl group.

3. The electrolyte as claimed in claim 1, wherein:
R is represented by Chemical Formula 2-1 or 2-2: 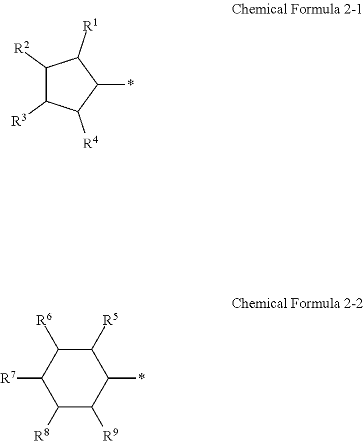
wherein, in Chemical Formulas 2-1 and 2-2,
R¹ to R⁹ are each independently a hydrogen atom, a halogen atom, or a C1 to C20 alkyl group.

4. The electrolyte as claimed in claim 3, wherein:
Chemical Formula 1 is represented by Chemical Formula 1-1 or 1-2: 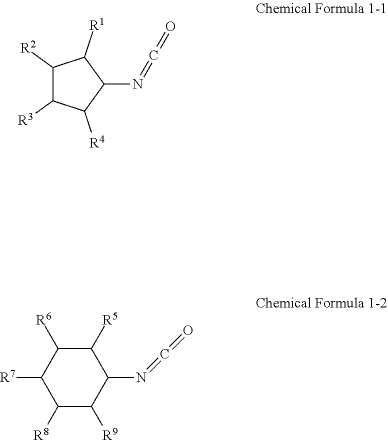
wherein, in Chemical Formulas 1-1 and 1-2,
R¹ to R⁹ are each independently a hydrogen atom, a halogen atom, or a C1 to C20 alkyl group.

5. The electrolyte as claimed in claim 4, wherein:
R¹ to R⁹ are all hydrogen atoms.

6. The electrolyte as claimed in claim 1, wherein:
the additive represented by Chemical Formula 1 is included in an amount of about 0.01 to about 10 wt % based on 100 wt % of a total amount of the electrolyte for a rechargeable lithium battery.

7. The electrolyte as claimed in claim 6, wherein:
the additive represented by Chemical Formula 1 is included in an amount of about 0.1 to about 5 wt % based on 100 wt % of a total amount of the electrolyte for a rechargeable lithium battery.

8. The electrolyte as claimed in claim 1, wherein:
the non-aqueous organic solvent comprises ethylene carbonate (EC), ethyl methyl carbonate (EMC), and diethyl carbonate (DEC).

9. The electrolyte as claimed in claim 1, wherein:
the lithium salt comprises LiPF₆.

10. The electrolyte as claimed in claim 1, wherein:
a molar concentration of the lithium salt in the electrolyte is about 1.0 to about 2.0 M.

11. A rechargeable lithium battery, comprising:
a positive electrode comprising a positive electrode active material;
a negative electrode comprising a negative electrode active material; and
the electrolyte as claimed in claim 1.

12. The rechargeable lithium battery as claimed in claim 11, wherein:
the positive electrode active material comprises a lithium nickel-based oxide, a lithium cobalt-based oxide, a lithium manganese-based oxide, a lithium iron phosphate-based compound, a cobalt-free lithium nickel-manganese-based oxide, or a combination thereof.

13. The rechargeable lithium battery as claimed in claim 12, wherein:
the positive electrode active material comprises a lithium iron phosphate-based compound represented by Chemical Formula 13: 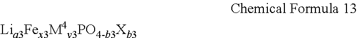
wherein, in Chemical Formula 13,
0.9≤a3≤1.8, 0.6≤x3≤1, 0≤y3≤0.4, and 0≤b3≤0.1,
M⁴ is one or more selected from among aluminum (Al), boron (B), barium (Ba), calcium (Ca), cerium (Ce), cobalt (Co), chromium (Cr), copper (Cu), magnesium (Mg), manganese (Mn), molybdenum (Mo), nickel (Ni), selenium (Se), silicon (Si), tin (Sn), strontium (Sr), titanium (Ti), vanadium (V), tungsten (W), yttrium (Y), zinc (Zn), and zirconium (Zr), and
X is one or more selected from among fluorine (F), phosphorus (P), and sulfur(S) (S).

14. The rechargeable lithium battery as claimed in claim 11, wherein:
the negative electrode active material comprises a Si-based negative electrode active material, a carbon-based negative electrode active material, or combination thereof.

15. The rechargeable lithium battery as claimed in claim 14, wherein:
the negative electrode active material comprises a carbon-based negative electrode active material.
